(19) United States
(12) Patent Application Publication
(10) Pub. No.: US 2007/0163758 A1
(43) Pub. Date: Jul. 19, 2007

(54) Fluid cooling device

(76) Inventor: Andreas Welsch, Holzmuhlerstr (DE)

Correspondence Address: ROYLANCE, ABRAMS, BERDO & GOODMAN, L.L.P., 1300 19TH STREET, N.W., SUITE 600, WASHINGTON,, DC, 20036, US

(21) Appl. No.: 10/559,927

(22) PCT Filed: Feb. 27, 2004
(86) PCT No.: PCT/EP04/01951

§ 371 Date: Mar. 16, 2006

(30) Foreign Application Priority Data
Jun. 17, 2003 (DE) 103 28 177.0
Jul. 10, 2003 (DE) 103 31 215.3

(51) Int. Cl. B29C 47/88; F24H 3/02

(52) U.S. Cl. 165/120; 165/121; 165/132

(57) ABSTRACT

The invention relates to a fluid cooling device in the form of a modular unit comprising a drive motor (10) which drives a ventilation wheel (12) which can be rotated in a ventilation housing (28). At least one fluid can be conveyed from a feed reservoir (20) into a hydraulic working circuit which, when in an operational state, basically heats the fluid and from which the cooled fluid returns to the feed reservoir (20). Parts of the feed reservoir (20) at least partially surround the ventilation wheel (12) and form the ventilation housing (28) which is preferably made of a plastic material, whereupon the ventilation housing is embodied as part of the feed reservoir, enabling the volume of the tank to be increased and resulting in increased damping of the noise of the ventilation wheel.

The invention relates to a fluid cooling device as a structural unit with a drive motor driving a rotating fan wheel in a fan housing, and at least one fluid can be conveyed from a reservoir tank into a hydraulic working circuit which basically heats the fluid in operation and which leads to an assigned heat exchanger from which the cooled fluid returns to the reservoir tank.

EP 0 968 371 B1 discloses a generic fluid cooling device with a trough-shaped reservoir tank configured as an oil tank that partially encloses the drive motor and the assigned fluid pump with high-drawn trough edges in the manner of a half shell. Between the high-drawn trough edges of the reservoir tank there is a housing part of sheet metal material which holds the fan wheel and which forms an air guide shaft for the heat exchanger through which the fluid is routed. In an extension of the housing part in the known solution, underneath the reservoir tank there is a base part which, for the purpose of mounting the device, is designed as a shoe, with the sole side having mounting bridges at least partially beyond the sole length. This known solution yields a relatively large-volume reservoir tank as an oil tank which however saves space in a compact design as a component of the fluid cooling device designed as a structural unit in that the tank reservoir at least partially encloses parts of the device in a space-saving manner. On the basis of the installation space which is left open by the trough edges, easy accessibility of the motor and fluid pump unit is furthermore ensured for purposes of installation and maintenance. Moreover, as a result of the aforementioned base part, reliable, space-saving attachment of the entire fluid cooling device to stationary components and housing walls is possible.

The sheet-metal housing part forming the fan housing for the fan wheel, which can be driven by means of the drive motor, on the one hand is cost-intensive to produce due to the diversity of parts and on the other hand during operation of the fan wheel vibrations can be transmitted to the sheet-metal housing part with unintended resonance effects. The sheet-metal housing is also hardly suited for damping fan noise during operation, so that operation of the known fluid cooling device is relatively loud. Due to the sheet-metal construction of the housing part there are moreover in part sharp transitions and shoulders within the air guide so that as a result of turbulence the free air flow in the area of the fan wheel is adversely affected; this in turn has an adverse effect on the cooling performance of the respective heat exchanger.

On the basis of this prior art, the object of the invention is to further improve the known solution while retaining its advantages such that a further reduction of the production and operating costs can be achieved with a simultaneous reduction of noise. This object is achieved by a fluid cooling device with the features in claim 1 in its entirety.

In that, as specified in the characterizing part of claim 1, parts of the reservoir tank at least partially enclose the fan wheel and in this way form the fan housing which preferably consists of a plastic material, the fan housing is designed as part of the reservoir tank, so that in this regard the complex sheet metalworking for producing a fan housing according to the known solution is eliminated. In contrast to the known sheet metal parts solution, the fan housing, consisting preferably of a plastic material, allows improved damping for fan-wheel noise; this applies especially to the case in which the reservoir tank with the fan housing is filled accordingly with fluid. This further improves the damping behavior. As a result of making the fan housing of plastic material the configuration possibilities within the scope of production processes for conventional plastic articles are expanded and increased, sharp transitions in the area of the air guide being avoidable, and continuous, uninterrupted air guidance preventing turbulence and flow losses; this is favorable in terms of energy and reduces the overall operating costs with the fluid cooling device as claimed in the invention.

In one preferred embodiment of the fluid cooling device as claimed in the invention, the drive motor drives at least one fluid pump which is mounted on a shaft line jointly with the rotating fan wheel and/or that the respective fluid pump provided with its own drive is a component of the fluid cooling device elsewhere. In the initially mentioned possibility the respective pump is integrated in a space-saving manner in the motor-pump-fan shaft line and for a different embodiment is provided elsewhere on the fluid cooling device, for example is seated on the tank with its own drive. Furthermore, it is in the domain of the cooling system as claimed in the invention to integrate the pump into the aforementioned hydraulic working circuit at a suitable location and in this way to provide fluid circulation between the fluid cooling device and other components of the hydraulic working circuit.

In one preferred embodiment of the fluid cooling device as claimed in the invention, the reservoir tank has a bottom-side trough part on which an upright-side trough part is seated and is integrally connected to the bottom-side trough part, the indicated trough parts forming a hollow collar in which the fan wheel is rotatably mounted. The bottom-side trough part is used especially for reliable and functionally dictated fixing of the entire fluid cooling device on machine parts; but it is also possible to place the fluid cooling device directly on the ground, a machine frame, or the like in a self-supporting manner. Conversely, the upright-side trough part forms a holding possibility for the fan wheel which can be integrated in this way in a space-saving manner into the reservoir tank, and proceeding from the upright-side trough part a holding possibility is created for the drive motor, for the fan wheel in addition to the respective fluid pump and assignable piping. Preferably it is furthermore provided that the hollow collar delimits a first opening cross section which is covered by the respective heat exchanger, and has a second opening cross section which faces the drive motor for the fan wheel.

In one especially preferred embodiment of the fluid cooling device as claimed in the invention, the opening cross section of the hollow collar facing the respective heat exchanger is chosen to be larger in cross section than the cross section of the opening cross section facing the drive motor, the pertinent change in cross section taking place continuously, in particular by means of tapering air guide surfaces. This yields a smooth, continuous cross section transition between the inflow opening and outflow opening of the hollow collar with the drivable fan wheel, so that a directed flow free of turbulence is largely obtained; this benefits fan wheel operation in terms of energy and therefore is favorable for the overall energy balance of the fluid cooling device. The indicated cross section can result from a round diameter or from a rectangular, especially also square diameter and from sectioned segments of round diameter components and those which run in a straight line.

In another preferred embodiment of the fluid cooling device as claimed in the invention, the upright-side trough part in the area of one free end of the trough-side trough part is mounted vertically standing on it, the longitudinal extension of the bottom-side trough part corresponding at least to the overall length of the respective fluid pump in addition to the drive motor. In this way, the static strength of the indicated cooling device is ensured to an especially high degree and the drivable components of the fan wheel, fluid pump, and drive motor are a component of the trough parts and accordingly of the reservoir tank such that possible vibrations during operation of the cooling device can be controlled reliably and failure-free and are transferred to the trough parts.

In another, especially preferred embodiment of the fluid cooling device as claimed in the invention, the reservoir tank has at least two tank chambers which are at least partially separated from each other, and in which a respective definable amount of an assignable fluid which supplies one hydraulic working circuit at a time can be stored. By preference provision is further made such that for each amount of fluid which can be separated in the reservoir tank by way of the individual tank chambers an independent heat exchanger and an independent fluid pump are provided. In this way at least two quantities of fluid of the same or different type can be stored in the reservoir tank, delivered to a hydraulic working circuit by way of its own respective assigned fluid pump, and can be cooled by an assigned heat exchanger after traversing the working circuit. The fluid is conventionally hydraulic oil, but also cooling and operating media such as a water-glycol mixtures or the like. Thus it is possible to store and cool several amounts of fluid with only one fluid cooling device.

Other advantageous embodiments are the subject matter of the other dependent claims.

The fluid cooling device as claimed in the invention is described in greater detail below using one embodiment as shown in the drawings, in which, in the form of schematic diagrams not drawn to scale,

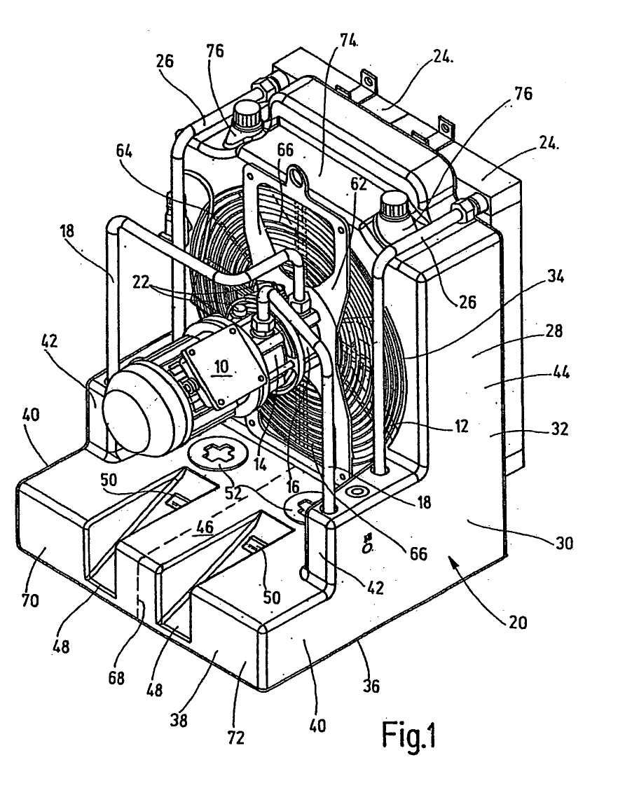

FIG. 1 shows in a perspective top view the rear area of the fluid cooling device;

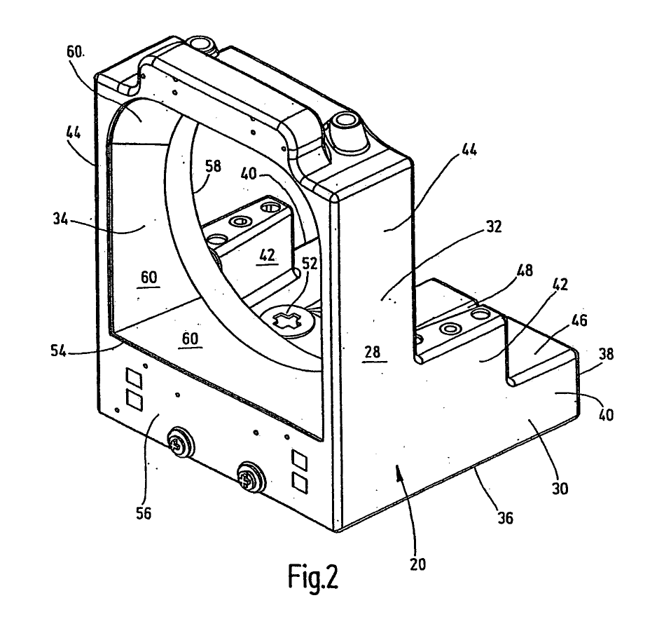

FIG. 2 shows a perspective front view of the reservoir tank, as is used in a fluid cooling device as shown in FIG. 1.

The fluid cooling device as claimed in the invention which is shown in FIG. 1 in its entirety is designed as a structural unit and can be commercially produced as such. In particular the fluid cooling device as claimed in the invention as shown in FIG. 1 can be integrated into the existing hydraulic circuits of propulsion machines or machine tools in order to thus effect fluid cooling of an operating medium, for example in the form of hydraulic oil. FIG. 1 shows the normal installation position of the fluid cooling device which can be mounted vertically in this installation position on parts of a plant floor or the like, but which can also be attached to machine and plant parts by way of its free side surfaces on the latter.

The fluid cooling device has an electric motor 10 of conventional design which drives a fan wheel 12 with individual fan wheel blades and two fluid pumps 14, 16. The respective fluid pump 14, 16 by way of a removal line 18 removes an assignable fluid, for example in the form of hydraulic oil, water-glycol or the like, from the reservoir tank which is designated as a whole as 20 and pumps the fluid by way of ports 22 into the piping of a hydraulic working circuit which is not detailed and to which for example a machine tool or a hydraulically actuated operational device is connected, furthermore preferably each fluid pump 14, 16 being assigned an independent hydraulic circuit. In the respective hydraulic working circuit the fluid then basically heats up accordingly and is then recooled to a definable temperature value by the fluid cooling device. This is done for each of the two circuits by a heat exchanger 24 (cooler) of conventional design from which the fluid which has been supplied by way of connecting points (not shown) can be returned to the reservoir tank 20 by way of discharge lines 26. The fan wheel 12 with the electric motor 10 is designed as an axial intake fan in which the air is intaken by way of the fins of the respective heat exchanger 24 which are not shown by way of the fan wheel in the direction of the electric motor 10 which in this way acquires additional cooling along its cooling ribs by the air flow. Viewed in the direction of looking at FIG. 1, the air flow travels therefore from right to left through the fan wheel 12. But the possibility also exists of modifying the fan wheel to operate the fluid cooling device shown in FIG. 1 as an axial pressure fan with the reverse flow sequence, if this should be feasible for practical purposes.

In contrast to the described embodiment, the possibility also exists of circulating an amount of fluid into and out of the reservoir tank 20 with only one fluid pump or more than two fluid pumps. Furthermore, it is possible with one or more fluid pumps to convey only one medium, for example, hydraulic oil; but it is also possible to convey different media in the form of different circuits, in addition to hydraulic oil also a cooling medium, for example in the form of water-glycol mixtures or the like. This separation of fluid amounts is described in greater detail below. The reservoir tank 20 consists of a plastic material, preferably of a polyethylene plastic material (LLDPE) and is produced preferably in one piece in a rotational molding process. As shown in FIGS. 1 and 2, parts of the reservoir tank 20 form the fan housing 20 which, as shown in the prior art, is not formed in this way from sheet metal parts, but from the indicated plastic materials, the fan housing 28 as part of the reservoir tank 20 forming a hollow chamber which encloses the fan wheel 12 on the outer circumferential side with a definable radial distance, and otherwise has a box-shaped structure to the outside.

The indicated reservoir tank 20 has a bottom-side trough part 30 on which an upright-side trough part 32 is placed and is integrally connected to the bottom-side trough part 30. The two indicated trough parts 30, 32 form a type of hollow collar 34 in which the fan wheel 12 is rotatably mounted. The bottom-side trough part 30 has a square bottom surface 36, and facing the viewer in the direction of looking at FIG. 1 a rear side surface 38 and two lateral terminating surfaces 40 which undergo transition by way of a hollow chamber-like gradation 42 into the lateral boundary surfaces 44 of the upright-like trough part 32. Between the two indicated gradations 42 the upper bottom plate of the bottom-side trough part 30 extends parallel to its bottom surface 36. For the bottom side trough part 30 hence a type of hollow plate-like base structure is formed on which the two gradations 42 are placed on the edge side in the same manner as the upright-side trough part 32 on one free end area of the bottom side trough part 30 which is opposite the rear side surface 38. In the upper bottom plate 46 there are two obliquely extending notches 48 which, each provided with a marking 50, permit readability of the maximum and minimum fill level in the reservoir tank 20, in the direction of looking from overhead, the drive motor 10 extending overhead between the two notches 48 and therefore not adversely affecting readability. If the upright-side trough part 32 is likewise to be provided with fluid, it is a good idea to provide fill level markings 50 laterally and in turn easily accessible and readable on the two lateral boundary surfaces 44 in the top area. Furthermore, there are reversible openings provided with end plugs 52 in the upper bottom plate 46 which facilitate cleaning of a tank or container from the outside after their removal.

The indicated hollow collar 34 has a first opening cross section 54 which is covered by the respective heat exchanger 24. FIG. 2 does not show the pertinent heat exchangers 24, for purposes of better representation. The pertinent heat exchangers 24 are supported in the installed state on the front side 56 of the reservoir tank 20 and in this way cover the first opening cross section 54 of the fan housing 28 which is designed as a hollow collar. The hollow collar 24 has another, second opening cross section 58 opposite the first opening cross section 54, which otherwise faces the drive motor 10 for the fan wheel 12. In the area of the second opening cross section 58 it is designed as a hollow cylinder and the wall thickness range of the hollow cylinder is such that the blades of the fan wheel 12 move driven circumferentially by means of the drive motor 10 with a definable radial distance along the hollow cylindrical second opening cross section. This opening cross section 54 of the hollow collar 34 which is facing the respective heat exchanger 24 is greater in diameter than the diameter of the opening cross section 58 facing the drive motor 10.

The pertinent cross-sectional change (compare FIG. 2) takes place continuously, especially by means of tapering air guide surfaces 60. As a result of these air guide surfaces 60, the rectangular cooler shape of the heat exchangers 24 changes continuously to the circular shape of the fan wheel 12. On the one hand the alignment of the air flow is thereby improved and it is thus ensured that the complete air stream also flows through the corners and edge areas of the heat exchangers 24. Thus the problem known in the prior art that, due to the design of the fan housing 28 as sheet metal housing parts, the fan diameter corresponds to the inner circle of the rectangular cooler (heat exchanger) with the resulting inadequate superficial air flow through the corner areas of the heat exchanger 24 is solved without having to install an oversized fan (fan wheel) with a diameter which corresponds to the imaginary outside circle of the otherwise rectangular cooler, for which proposals can likewise be found in the prior art. This optimization according to the fluid cooling device as claimed in the invention leads to smaller structural space with higher power density, at the same time a lighter structural shape than in the known solutions being attainable. The cross-sectional change need not be present over the entire area of the hollow collar 34 in the front area of the inflow direction, rather here transitions extending in a straight line can also be present, especially in the area of the lateral boundary surfaces 44; but it is important that quasi-continuous air guidance between the first opening cross section 54 and the second opening cross section 58 is achieved.

In that the reservoir tank 20 with its bottom-side trough part 30 and with its upright-side trough part 32 forms the fan housing according to the solution as claimed in the invention, the noise propagation of the fan wheel is greatly damped and thus the conventional fan noise is markedly reduced. This damping effect can be improved if the reservoir tank 20 is also filled with fluid in the area of the upright-side trough part 32. Furthermore, the air guidance area between the first opening cross section 54 and the second opening cross section 58 with the air guide surfaces 60 can be used as a cooling surface since it is in direct contact with the fluid medium. This solution also greatly increases the tank volume to be stored since the fan housing 28 can now be used as additional tank volume.

The upright-side trough part 32 in the area of one free end of the bottom-side trough part 30 is mounted standing vertically on the latter and the longitudinal extension of the bottom side trough part 30 is such that it corresponds at least to the overall length of the respective fluid pump 14, 16 in addition to the drive motor 10 (compare FIG. 1). To fix the position of the latter assembly, in the area of the second opening cross section 58, a holding plate 62 is used which extends transversely over the latter and which is securely joined to the back of the upright-side wall part 32, for example by way of a screw connection, and to increase reliability, between the holding plate 62 and the actual fan wheel 12 there is a fan grating 64 which does permit passage of air, but otherwise ensures that an operator does not reach unintentionally into the high speed fan wheel 12 when the fluid cooling device is in operation. The longitudinal axis of the electric motor 10 and of the first and second fluid pump 14, 16 proceeds parallel to the upper bottom plate 46 of the bottom-side trough part 30 and the rotary support for the fan wheel 12 is integrated in the holding plate 62 at the same time. The pertinent angular configuration of the reservoir tank 20 with the freely projecting electric motor 10 has proven exceedingly vibration-resistant in practical tests and in axial intake air operation of the fan wheel 12 also allows optimum cooling of the electric motor 10. In this respect, the holding plate 62 has the corresponding recesses 66 in order to adversely affect the free air passage by way of the opening cross section 54, 58 as little as possible.

In this embodiment of the fluid cooling device as claimed in the invention, the reservoir tank 20 is divided into two tank chambers 70, 72 which are separated from each other by way of a single or double partition wall 68 which extends however only along the bottom-side trough part 30 in this exemplary embodiment. In each of the two tank chambers 70, 72 there is a definable amount of an assignable fluid, for example in the form of a hydraulic medium; but the possibility also exists of filling one tank chamber with one type of fluid, for example in the form of a hydraulic medium, and to fill the other tank chamber with another type of fluid, for example with a coolant in the form of an emulsion which contains water-glycol or the like. Accordingly it is possible to deliver fluid of the same type or two fluids of different type with the two fluid pumps 14, 16 separately from each other. Depending on the respective pump output for the two fluid pumps 14, 16, in this way faster cooling circuit circulation can be achieved and likewise the cooling performance can be adjusted by a suitable choice of a heat exchanger 24 and its size. Thus, with the fluid cooling device cooling and optionally also heating tasks to be performed can be carried out across a wide range when the systems are started with a fluid such as a hydraulic medium.

Furthermore, the number of tank chambers (not shown) can be further increased, and then preferably one fluid pump each would be assigned to one or more tank chambers connected to each other, and in the corresponding circuit a corresponding heat exchanger or cooler 24. If the upright-side trough part 32 is to also have a respective separate chamber volume, the indicated partition wall 68 would also be implemented accordingly in the pertinent upright-side wall part 32. If the partition wall 68 is designed as a double chamber partition wall which optionally forms a recess which can be filled with ambient air toward the bottom surface 36 of the bottom-side trough part 30, especially good heat insulation and reliable media separation between the two chambers 70, 72 can thus be achieved.

The hollow collar 34 as a fan housing 28 on its side 74 facing away from the bottom-side trough part 30 has two tank openings 76 by which the fluid medium can be delivered to the reservoir tank 20. This configuration of the fill openings 76 on the top side of the fluid cooling device is very easy to service due to good accessibility. This service-friendly configuration arises because the fan housing 28 is designed as a tank structure. It has furthermore proven especially advantageous to use a milky-cloudy plastic in order to permit optical checking of the fill level display for operators or maintenance personnel. The milky cloudiness of the plastic moreover protects the respective fluid medium against ageing, due to ambient light for example. In particular the reading possibility using the marking 50 along the notches 48 in the upper bottom plate 46 of the bottom-side trough part 30 has proven advantageous. The reservoir tank 20 can be produced especially economically from polyethylene material in a rotational molding process.

1. A fluid cooling device as a structural unit with a drive motor (10) driving a rotating fan wheel (12) in a fan housing (28), and at least one fluid can be conveyed from a reservoir tank (20) into a hydraulic working circuit which basically heats the fluid in operation and which leads to an assigned heat exchanger (24) from which the fluid returns cooled to the reservoir tank (20), characterized in that parts of the reservoir tank (20) at least partially enclose the fan wheel (12) and in this way form the fan housing (28) which preferably consists of a plastic material.

2. The fluid cooling device as claimed in claim 1, wherein the drive motor (10) drives at least one fluid pump (14, 16) which is mounted on a shaft line jointly with the rotating fan wheel (12) and/or wherein the respective fluid pump (14, 16) provided with its own drive is a component of the fluid cooling device elsewhere.

3. The fluid cooling device as claimed in claim 1, wherein the reservoir tank (20) has a bottom-side trough part (30) on which an upright-side trough part (32) is seated and is integrally connected to the bottom-side trough part (30), and wherein the indicated trough parts (30, 32) form a hollow collar (34) in which the fan wheel (12) is rotatably mounted.

4. The fluid cooling device as claimed in claim 3, wherein the hollow collar (34) delimits a first opening cross section (54) which is covered by the respective heat exchanger (24), and has a second opening cross section (58) which faces the drive motor (10) for the fan wheel (12).

5. The fluid cooling device as claimed in claim 4, wherein the opening cross section (54) of the hollow collar (34) which faces the respective heat exchanger (24), is chosen to be larger in free cross section than the cross section of the opening cross section (58) facing the drive motor (10), and wherein the pertinent change in cross section takes place continuously, especially by means of tapering air guide surfaces (60).

6. The fluid cooling device as claimed in claim 3, wherein the upright-side trough part (32) in the area of one free end of the bottom-side trough part (30) is mounted vertically standing on it and wherein the longitudinal extension of the bottom-side trough part (30) corresponds at least to the overall length of the respective fluid pump (14, 16) in addition to the drive motor (10).

7. The fluid cooling device as claimed in claim 1, wherein the reservoir tank (20) has at least two tank chambers (70, 72) which are at least partially separated from each other, and in which a respective definable amount of an assignable fluid which supplies one hydraulic working circuit at a time can be stored.

8. The fluid cooling device as claimed in claim 7, wherein for each amount of fluid which can be separated in the reservoir tank (20) by way of the individual tank chambers (70, 72) an independent heat exchanger (24) and an independent fluid pump (14, 16) are provided.

9. The fluid cooling device as claimed in claim 7, wherein the hollow collar (34) on its side facing away from the bottom-side trough part (30) has tank openings (76) for supplying fluid to the respective reservoir chamber (70, 72).

10. The fluid cooling device as claimed in claim 1, wherein the reservoir tank (30) is produced from polyethylene material as plastic in a rotational molding process.
